(19) United States
(12) Patent Application Publication
(10) Pub. No.: US 2024/0130392 A1
(43) Pub. Date: Apr. 25, 2024

(54) SOLUBLE CASCARA POWDER AND METHODS OF PREPARING SOLUBLE CASCARA POWDERS

(71) Applicant: OLAM AMERICAS, LLC, Fresno, CA (US)

(72) Inventors: Siva Subramanian Chittor Gopalakrishnan, Naperville, IL (US); Leonard S. Fong, Naperville, IL (US); Francis John Yap Sun, Arlington Heights, IL (US)

(21) Appl. No.: 18/380,032

(22) Filed: Oct. 13, 2023

Related U.S. Application Data
(60) Provisional application No. 63/416,046, filed on Oct. 14, 2022.

(51) Int. Cl. A23F 5/40; A23F 5/38

(52) U.S. Cl. CPC A23F 5/40; A23F 5/385

(57) ABSTRACT

A soluble cascara powder product with improved compositional and sensory characteristics, for use in food and beverage products is provided, as well as methods of preparing the soluble cascara powder. The soluble cascara powder may be a blend of powders derived from coffee cherry fruit to create a highly palatable and novel soluble cascara powder product, and one with desirable compositional characteristics such as phenolic content and bioactive compound content. Example methods of processing of the coffee fruit to prepare the soluble cascara powder may also result in soluble cascara powder that will result in advantageously low turbidity levels when used in beverage compositions.

### CROSS-REFERENCE TO RELATED APPLICATIONS

The present application claims the priority benefit of U.S. Provisional Application No. 63/416,046, filed Oct. 14, 2022, which is hereby incorporated herein by reference in its entirety.

### TECHNICAL FIELD

Aspects of the disclosure relate to a soluble cascara powder and methods of making soluble cascara powder. The disclosure also relates to a soluble cascara powder compositions and methods of making them where the cascara powders are blends of multiple types cascara material, including for example cascaras derived from at least two distinct coffee cherries with different physical and chemical properties and/or cascaras that are processed differently in a manner that will result in different physical and chemical properties (even if from the same coffee cherry source). Such soluble cascara powders may have an enhanced yield and enhanced sensory characteristics compared to dried cascara powder derived from a single coffee cherry source.

### BACKGROUND

Coffee has been and continues to be a commodity, purchased and consumed worldwide. At a high level, the production of coffee typically includes harvesting coffee cherries, processing these coffee cherries to remove the coffee beans from the coffee cherry (coffee cherries typically include two beans fermentation drying, sorting, grading and roasting the coffee beans. The fruit part of the coffee cherry which includes the skin and the pulp is customarily discarded during processing after the coffee beans are expelled, resulting in billions of pounds of waste per year. Some coffee fruit is used as compost, but the majority of the coffee fruit is discarded into landfills, creating an environmental burden. The sugars and polyphenols present in the coffee fruit are valuable as food ingredients. Therefore, a need exists in the industry for utilizing the byproducts of coffee processing, or otherwise upcycling coffee cherry fruit, using the solids to prepare a food and beverage ingredient.

In some instances, the skin of coffee cherries is dried following removal of the coffee beans. The dried skins of these coffee cherries with the adhering pulp are referred to as “cascara”. During the processing of the coffee cherry to green coffee, there are two main methods used: The natural or dry process and the wet or washed process. The natural or dry process includes harvesting the coffee cherry and drying it under sunlight. The dried cherries are hulled to obtain the coffee bean and the coffee husk. This coffee husk obtained by the dry processing method is referred to as “husk cascara.” The wet or washed process includes harvesting the coffee cherry and de-pulping the cherry to separate the beans from the fruit by using a pressing mechanism. This process separates the coffee fruit from the beans which are covered with a layer of mucilage and a parchment layer in which the coffee beans are embedded. The separated coffee fruit can be sun dried or machine dried to obtain the “pulped cascara.” Husk cascara and pulped cascara each are types of cascara as used herein. Husk cascara and pulped cascara have different compositions including the amounts and types of carbohydrates, sugars, dietary fiber and phenolics that are present. In the case of the husk cascara, the sugars are typically higher and more astringent, as the coffee cherry does not come in contact with water during the pulping process.

Cascara can be added to or steeped in hot water to create cascara tea or coffee cherry tea. The cascara typically imparts a cooked or stewed tea flavor to the beverage. Moreover, the microbiological load contained in cascara varies significantly across cascaras based on origin, manufacturing facilities, etc. As such, a need exists for a cascara powder product that is soluble in a liquid or semisolid with improved sensory characteristics and microbiological consistency and safety compared to dried cascara. Further, the need exists for optimum use of soluble cascara powder yet result in a highly palatable product for consumers.

### SUMMARY

This Summary provides an introduction to some general concepts relating to this disclosure in a simplified form, where the general concepts are further described below in the Detailed Description. This Summary is not intended to identify key features or essential features of the disclosure.

Aspects of this disclosure relate generally to processes for producing a soluble cascara powder product, wherein the coffee cherry fruit from which the soluble cascara product is derived is de-pulped to separate the beans from the fruit and the coffee cherry fruit is further processed to form a cascara. Another aspect of this disclosure relates to processes for producing a soluble cascara powder, wherein the coffee cherry fruit is derived from “husk cascara” where the husk is separated post-drying of the whole coffee cherry. The cascara product may then be further processed including by pre-soaking, extracting, concentrating and spray drying to from a soluble cascara powder.

In another aspect of this disclosure, a soluble cascara powder product is prepared by blending powders derived from different coffee cherries grown and harvested in different geographic locations to arrive at a soluble cascara powder blend with enhanced sensory characteristics and optimum polyphenol levels.

In one aspect of the disclosure, a soluble cascara powder product is provided, the product including a first soluble cascara powder derived from a first coffee cherry fruit, where the first coffee cherry fruit has a soluble solids content of at least 12%. The first coffee cherry fruit may be subject to processing including wet pulping to separate the first coffee fruit from coffee beans and drying the separated first coffee fruit, for example to a water activity at 25° C. of between about 0.3-0.65. The steps may include one or more of washing the fruit, floatation to separate mature cherries, de-pulping, collecting the coffee fruit and drying to produce dry cascara. Further steps may include extraction of solids from cascara, for example via presoaking and/or through an extraction solvent, e.g. using hot water and other techniques. As one example, an extraction solvent may be hot water at about 85-95° C. (or about 60-100° C.) and the extraction may be performed for about 120 minutes or more (or 60 minutes or more), to form a first cascara extract. The steps may include concentrating the first cascara extract to a soluble solids content of about 20-30% to form a first concentrated extract, encapsulating the first concentrated extract with a carrier and spray drying the first concentrated extract. The first soluble cascara powder may include total phenolics in an amount of about 50 GAE/g or more, or about 55-70 mg GAE/g. The first soluble cascara powder may include about 0.5-1.2% caffeine. The first soluble cascara powder may include about 9-13 g dietary fiber per 100 g or about 8 or more g dietary fiber per 100 g. The first soluble cascara powder may include about 5-10 g sugar per 100 g, or about 5 or more g sugar per 100 g.

The soluble cascara powder product may include a second soluble cascara powder, for example a cascara powder derived from a second coffee cherry fruit. The second coffee cherry fruit may have a soluble solids content of at least 12%. The second coffee cherry fruit may be subject to processing including wet pulping to separate the second coffee fruit from coffee beans and drying the separated second coffee fruit, for example to a water activity at 25° C. of between about 0.3-0.65. The steps may include washing the fruit, floatation to separate mature cherries, de-pulping, collecting the coffee fruit and drying to produce dry cascara. Further steps may include extraction of solids from cascara using hot water and other techniques e.g. hot water at about 85-95° C. for about 120 minutes or more to form a second cascara extract. The steps may include concentrating the second cascara extract to a soluble solids content of about 20-30% to form a second concentrated extract, encapsulating the second concentrated extract with a carrier and spray drying the second concentrated extract. The first soluble cascara powder may include total phenolics in an amount of about 20 GAE/g or more, or about 20-35 mg GAE/g. The first soluble cascara powder may include about 0.5-1.2% caffeine. The first soluble cascara powder may include about 5-8 g dietary fiber per 100 g or about 5 or more g dietary fiber per 100 g. The first soluble cascara powder may include about 20-35 g sugar per 100 g, or about 20 or more g sugar per 100 g.

The soluble cascara powder product may include a blend of a first soluble cascara powder and a second soluble cascara powder (e.g. like those discussed above in the summary, but not limited to such example cascara extract powders) to obtain a soluble cascara powder product. The product may include caffeine in an amount of about 0.5-2.0%, a total phenolic content of about 30-55 mg GAE/g per 100 g, dietary fiber of about 5-12 g per 100 g, and total sugars in an amount of about 10-20 g per 100 g. A ratio in the soluble cascara powder product of the first coffee cherry fruit to the second coffee cherry fruit prior to processing may be between about 55:45 and about 65:35, and the ratio in the soluble cascara powder product of the first soluble cascara powder to the second soluble cascara powder may be between about 0.95:1.05 and about 1:05:0.95.

In some examples, the first soluble cascara powder may have a gallic acid content of about 1800-2500 μg/g. In certain examples, the second soluble cascara powder may have a gallic acid content of about 20-50 μg/g. In some examples, the soluble cascara powder product is added to a beverage product, for example in an amount of about 2.5-7.5 g or about 5.5-7.5 g or about 2.5-10 g of cascara powder product per 350 ml of beverage product. In some examples, the solids yield of the first coffee cherry fruit is about 35% and the yield of the second coffee cherry fruit is about 45%. In certain embodiments, the soluble cascara powder product includes a total phenolic content of at least about 20, 30 or 40 mg GAE/g.

In certain embodiments, a carrier is used to encapsulate any concentrated extract, such as the first and the second concentrated extracts, where the carrier one or more of maltodextrin, inulin, cyclodextrins, gum arabic, other encapsulating agents, and anti-caking agents. In some examples, the first soluble cascara powder has a microbiological load of less than 50,000 CFU (colony forming units). In some examples, the second soluble cascara powder has a microbiological load of less than 50,000 CFU. In certain examples the soluble cascara powder product has a microbiological load of less than 50,000 CFU. In some examples, all of the first and second soluble cascara powder and the blended soluble cascara powder product have a microbiological load of less than 50,000 CFU.

In some aspects, the disclosure relates to a soluble cascara powder product that includes a blend of a first soluble cascara powder and a second soluble cascara powder. The soluble cascara powder product may include a first soluble cascara powder that includes a total phenolic content in an amount of 55-70 mg GAE/g, 0.5-1.2% caffeine, 9-13 g dietary fiber per 100 g, and 5-10 g sugar per 100 g. In some examples, the product includes a second soluble cascara powder that includes total phenolic content of about 20-35 mg GAE/g, 0.5-1.2% caffeine, 5-8 g dietary fiber per 100 g, and 20-35 g sugar per 100 g. The soluble cascara powder product may include a blend of the first soluble cascara powder and the second soluble cascara powder to obtain a soluble cascara powder product comprising caffeine in an amount of about 0.5-2.0%, a total phenolic content of about 30-55 mg GAE/g per 100 g, dietary fiber of about 5-12 g per 100 g, and total sugars in an amount of about 10-20 g per 100 g. In some examples, the ratio in the soluble cascara powder product of the first soluble cascara powder to the second soluble cascara powder is between about 0.95:1.05 and about 1:05:0.95.

In some aspects of the disclosure, a soluble cascara powder product provides a turbidity of 100 or less NTU, or 75 or less NTU, or 50 or less NTU, or 30 or less NTU, or 20 or less NTU, at an aqueous concentration of 0.3%. In some examples, the soluble cascara powder product provides a turbidity 100-500 NTU at an aqueous concentration of 0.3%, or a turbidity of 400 NTU or less, or 350 NTU or less, or 300 NTU or less, or 250 NTU or less, or 200 NTU or less. The soluble cascara powder product may have a microbiological load of less than 50,000 CFU. The soluble cascara powder product may be incorporated into a beverage product, or an edible/consumable food product.

in some examples, the cascara powder extract has a hydrogen atom transfer activity level of 13,000-34,000 enol Trolox/100 g sample as measured by a ORAC assay. In some examples, the cascara powder extract has a single electron transfer activity level of 6,000-21,000 μmol Trolox/100 g sample as measured by a ABTS assay. In some examples, the cascara powder extract has a prooxidant activity level such that a 1.25mg/mL sample produces 1.2-5.6 μM of hydrogen peroxide over 24 hours.

In some aspects of the disclosure, processes for the preparation of soluble cascara powder and/or soluble cascara powder products are provided. In some examples, processes for the preparation of a soluble cascara powder product are provided that include a wet pulping step to separate coffee fruit from coffee beans, drying the separated coffee fruit, extracting cascara from the separated coffee fruit, for example by treating the coffee fruit with sonication in a solvent at a temperature that is 65° or higher to provide a first cascara powder extract, concentrating the first cascara powder extract to a soluble solids content of at least 20% to form a first concentrated cascara powder extract, encapsulating the concentrated extract with a carrier, and spray drying the first concentrated cascara powder extract.

In some aspects of the process, the process includes performing a dewatering treatment on the separated coffee fruit after the sonication treatment. In other aspects of the process, however, no dewatering treatment is performed. In some examples, the process further includes adding the encapsulated concentrated cascara extract into a beverage or edible food product.

In certain examples, the process includes blending the first concentrated cascara powder extract with a second cascara powder, wherein the second concentrated cascara powder extract is made from a second, different type of coffee fruit, or the second concentrated cascara powder extract is made from the same coffee fruit but from a different processing method, or where the second concentrated cascara powder extract is made from a second, different type of coffee fruit and second concentrated cascara powder extract is made from a different processing method.

These and other aspects, along with advantages and features of the present disclosure herein disclosed, will become apparent through reference to the following description. Furthermore, it is to be understood that the features of the various embodiments described herein are not mutually exclusive and can exist in various combinations and permutations.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1 depicts an exemplary coffee cherry, and identifies the skin, pulp, mucilage, parchment, silverskin and bean.

FIG. 2 illustrates a process flow chart for processing coffee cherry fruit from harvesting to preparing cascara that is subsequently further manufactured as illustrated in FIG. 3.

FIG. 3 illustrates a flow chart for processing soluble cascara powder from cascara, as well as further packaging and distribution of the soluble cascara powder.

FIG. 4 is a graph illustrating the perceived aromas for cascaras derived from coffee cherries grown and harvested in Laos, Zambia, Peru, Indonesia, Tanzania, and Democratic Republic of Congo (“DRC”).

FIG. 5 is a biplot illustrating the chemical compounds and the amounts of perceived aromas associated with each for cascaras derived from coffee cherries grown and harvested in Laos, Peru, Indonesia, Tanzania, and DRC.

### DETAILED DESCRIPTION

In the following description of the various examples and components of this disclosure, reference is made to the accompanying drawings, which form a part hereof, and in which are shown by way of illustration various example processes, materials, products and environments in which aspects of the disclosure may be practiced. It is to be understood that other steps, materials, structures and environments may be utilized and that structural and functional modification may be made from the specifically described steps, materials, structures, environments and methods without department from the scope of the present disclosure. It is also to be understood that the specific materials, systems, devices and processes described in the following specification, are simply examples. Hence, specific dimensions and other physical characteristics relating to the examples disclosed herein are not to be considered as limiting unless explicitly stated to be so.

Ranges and numerical values: throughout this disclosure, various aspects of the disclosure can be presented in a range format, either open or closed. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 10 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. It should also be understood that any and all whole or partial integers between any ranges set forth herein are included herein. It should also be understood that any values in this disclosure may establish a threshold level, for example an example embodiment with a concentration of 5-CQA of 625 μg/g shows that embodiments of this disclosure include cascara extracts with a concentration of 5-CQA that is at least 625 μg/g.

Aspects of this disclosure relate to soluble cascara extracts and methods for making soluble cascara extracts. These and other aspects, features and advantages of the disclosure or of certain examples of the disclosure will be further understood by those skilled in the art from the following description of examples. It is to be understood that other modifications may be made from the specifically described products, methods and systems without departing from the scope of the present disclosure. The soluble cascara extracts in accordance with the present disclosure may exhibit enhanced sensory and compositional characteristics. In certain aspects, the soluble cascara extracts are soluble cascara powders. In aspects of the present disclosure, the cascara is processed to form a soluble cascara powder having a microbiological load of less than about 50,000 CFU, while also meeting the applicable food safety requirements.

Infusions of cascara tea can be made by steeping cascara with water at various temperatures and filtration of the solution. For industrial manufacturing of beverage, a soluble extract powder will be the most convenient form. As used herein, “soluble cascara powder(s)” is a powder produced from the extract which is soluble in water with slight cloudiness, but without any significant settlement of residue, and shelf stable. As indicated here, soluble cascara powder may result, depending on concentration, in turbidity or opaqueness of water or other solvent material(s) containing the powder due to the presence of solids from the powder.

In some examples, the soluble cascara powder may, at a concentration of 0.3% by weight in water, provide a turbidity measuring about 50 of nephelometric turbidity units (NTU) or less (as measured by a Hach 2100QIS Turbidimeter, which was used to measure the samples of this disclosure, by measuring solutions with 0.3% by weight of cascara in water at ˜21 degrees Celsius), or about 40 NTU or less, or about 30 NTU or less, or about 25 NTU or less, or about 20 NTU or less, or about 17 NFU or less, or about 15 NW or less, of about 13 NTU or less. In some examples, the soluble cascara powder may, at a concentration of 0.3% by weight in water, provide a turbidity measuring about 15 to about 50 NTU, about 20 to about 50 NTU, about 25 to about 75, about 15 to about 20 NTU, about 15 to about 25 NTU, or about 15 to about 100 NTU, or about 100 NTU or less, or about 75 NTU or less, or about 50 NTU or less, or about 25 NTU or less, or about 20 NTU or less, or about 15 NTU or less. As discussed in more detail below, these powders can provide beverages or other edible compositions that are relatively clear despite significant levels of extracted cascara solids, for example a soluble cascara powder may, at a concentration of 0.3% by weight in water, provide a turbidity measuring about 20 NTU or less with a soluble solids content of about 30% or more, or 30-35%, for example a turbidity of about 16 or less with a soluble solids content of about 31.5-32.5%, or a turbidity of about 14-16 with a soluble solids content of about 31.5-32.5%. Other levels may also be reached by the methods discussed herein, for example through process step selections and selection of starting material characteristics. For example, for example a soluble cascara powder may, at a concentration of 0.3% by weight in water, provide a turbidity measuring about 100 NTU or less with a soluble solids content of about 30-35% or more, for example a turbidity of about 90 or less with a soluble solids content of about 32%, or a turbidity of about 110 or less with a soluble solids content of about 36%.

In some embodiments, in particular those prepared via methods that result in even higher extraction of soluble solids, the NM may be higher. Such compositions may be suitable for other applications where visual appearance and clarity is not as strongly desired, for example an application that already contains opaque component(s) fit for consumption. in some examples, the soluble cascara powder may, at a concentration of 0.3% by weight in water, provide a turbidity measuring about 300 to about 350 NTU, or about 300 to about 375 NTU, or about 300 to about 400 NTU, or about 300 to about 500 NTU, or about 200 to about 500 NTU, or 500 NTU or less, or about 400 NTU or less, or about 300 NTU or less, or about 350 NTU or less. In some applications, such as beverages akin to iced teas or soft drinks, low levels of turbidity from any cascara may be desirable. Thus, for some application, it may be desirable to balance processing steps that can influence the removal of cascara solids, sugars, and constituent components such as phenolics. For example, ultrasonication can advantageously increase solids extraction e.g. by increasing the porosity of cell structure. But extraction steps can also increase in heightened levels of pectin which can drive up turbidity levels. Thus, for at least some applications, the cascara powder is prepared in a manner to provide substantial yields of cascara solids but avoid undesirable levels of pectin as detailed below, e.g. pulped cascara fruit processing with hot water extraction and sonication of the coffee fruit, but without a pressing or dewatering step. But in some applications other steps are used, e.g. cascara is husked or dewatering is still used. For example, beverages or food products are sufficiently opaque (e.g. those with milk solids) that turbidity may not be a concern for example in cookies, ice cream and other products, and higher NTU cascaras are desirable.

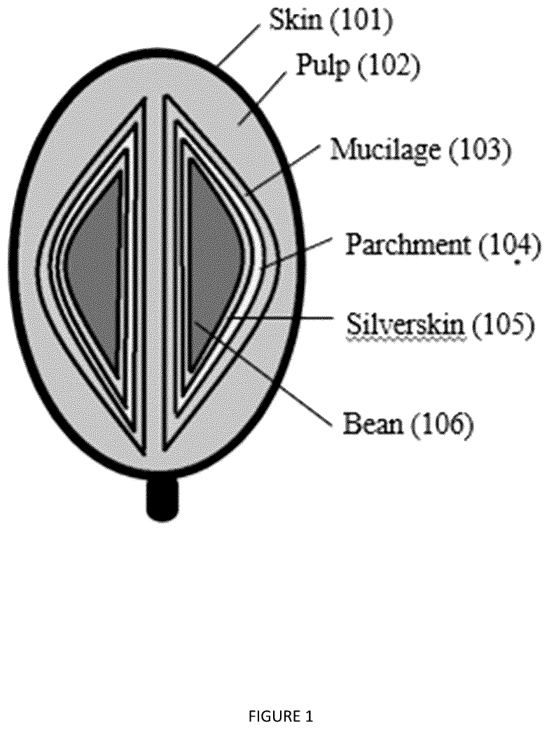

As used herein the term “cascara” refers to dried coffee fruit. Portions of an exemplary coffee cherry are shown and described in FIG. 1. Cascara may include the skin (exocarp) (101), pulp (mesocarp) (102) and a portion of the mucilage (pectin layer) (103) that is dried. In some instances cascara may also include portions of the parchment (endocarp) (104) in addition to the skin, pulp and mucilage and optionally portions of the silverskin (105) and bean (106). “Polyphenols” as used herein means naturally occurring organic compounds having multiple phenol units, including, without limitation one or more of, chlorogenic acid (CGA) isomers such as 3-caffeoylquinic acid (3-CQA), 4-caffeoylquinic acid (4-CQA), 5-caffeoylquinic acid (5-CQA), 3,5-diCaffeoylquinic acid (3.5-diCQA), 3,4-diCaffeoylquinic acid (3,4-diCQA), 4,5-diCaffeoylquinic acid (4,5-diCQA), 3-feruloylquinic acid (3-FQA), 4-feruloylquinic acid (4-FQA), 5-feruloylquinic acid (5-FQA), 3-ρ-coumarolyquinic acid (3-ρ-CoQA), 4-ρ-coumarolyquinic acid (4-ρ-CoQA), 5-ρ-coumarolyquinic acid (5-ρ-CoQA), as well as protocatechuic acid, troxerutin, mangiferin, gallic acid, caffeine, rutin, and ρ-coumaric acid.

As shown in FIG. 1, the coffee cherry consists of the skin (101), pulp (102), mucilage (103), parchment (104), silverskin (epidermis) (105) and the bean (seeds inside) (106). The “coffee cherry fruit” as described herein includes one or more of all or portions of the skin, pulp, mucilage, and parchment. This coffee cherry fruit is further processed in aspects of this disclosure. In one example, the skin, pulp, some part of the mucilage, and optionally the parchment, is processed and subjected to extraction to obtain microbiologically safe soluble solids and then concentrated and spray dried to create a food ingredient in a convenient and soluble form for use as beverage and food ingredient for a variety of applications including infusions and teas.

In an aspect of the disclosure, the starting coffee cherries are grown and harvested in one or more geographic locations. The coffee cherries originating from these various geographic locations have been found to have distinct characteristics. For example, the coffee cherries differ in their soluble solids content, color, aroma, amount and types of polyphenols, pH, and dietary fiber, as well as other sensory attributes.

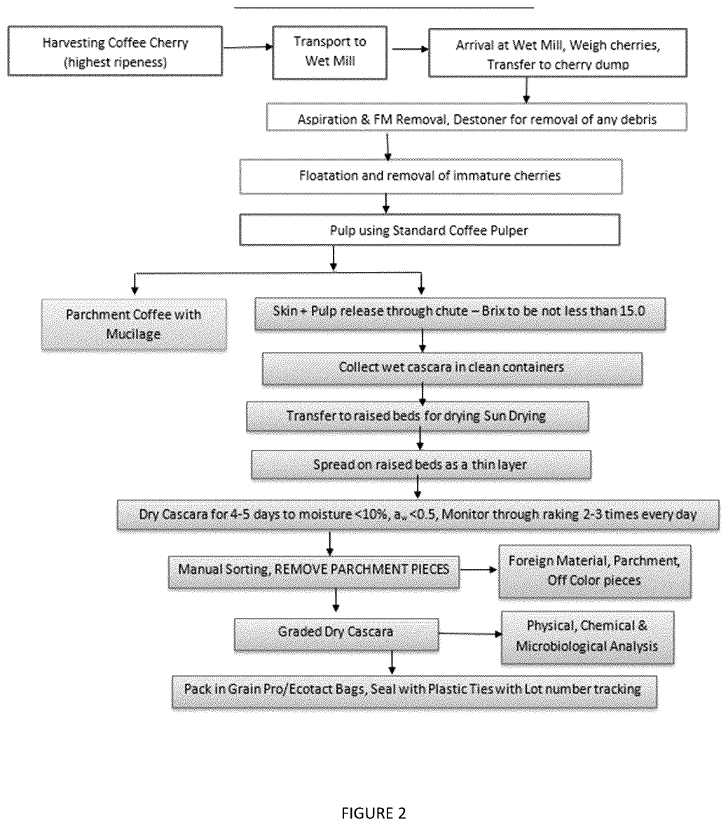

In one example, the coffee cherries are harvested from a geographic location selected from Laos, Indonesia, Tanzania, Peru, Democratic Republic of Congo, or Zambia. Cherries at any ripeness may be used; however, harvesting coffee cherries at their highest ripeness is preferable. Exemplary initial processing steps are shown in FIG. 2, and initial processing may include a subset of steps. In particular, ripe coffee cherries having a soluble solids content greater than 14% of the coffee fruit are processed. The coffee cherries may be transported to a wet mill and subsequently transferred to a cherry dump where the cherries are aspirated and destoned for removal of any debris. Next, the cherries may be subjected to floatation to remove immature cherries. The coffee cherries may then be pulped, for example using a standard coffee pulper. Horizontal or vertical coffee pulping machines can be used. During pulping, water usage is minimized to reduce the loss of soluble solids through the water stream. In examples of the disclosure, water usage during pulping and/or transport of pulped cascara is minimized such that the amount of water absorbed by the coffee fruit makes water about 50% or less of the weight of the coffee cherries that are pulped, or about 55% or less, or about 60% or less, or about 45% or less. Using, for example, an amount of water such that water is about 50% or less of the weight of the coffee cherries has been determined to help maintain desirable solids levels by avoiding undesirable levels of dilution of sugar and other soluble solids, which can also complicate drying and increase the risk of mold growth during drying. Coffee fruit which is separated during the pulping process is collected using hygienic methods with a soluble solids target of at least 12%, and in some instances a soluble solids target of at least 14%. The coffee fruit collected contains the skin, pulp, and portions of the mucilage and potentially portions of the parchment of the fruit. During this wet pulping, the majority of the mucilage, parchment, as well as the silverskin, along with the beans, are removed from the coffee cherry fruit. These components are further processed in a different processing stream.

The skin and pulp may be further processed. For example, the coffee cherry skins and pulps can be released through a chute. In a further example, only coffee cherry skins and pulps having a Brix not less than 12.0 are released through the chute for further processing. The wet coffee fruit may then be collected in clean containers and then dried. The coffee cherries may be dried by any suitable methods for drying, including, without limitation, sun drying or mechanically drying. In one example, the wet coffee fruit is transferred to raised beds for sun drying, including raking the cherries to spread in a thin layer on the raised beds. The coffee cherries can be dried, for example, for 4-5 days, raking 2-3 times per day while drying. Temperature and humidity control may be maintained to limit mold growth. In one example, the coffee cherries are dried to a moisture of less than 10% or a water activity of less than 0.60 to form cascara.

In another example, coffee cherries with the highest ripeness are chosen and sun-dried to a moisture content of less than 12%. The dried cherries are hulled in a hulling machine and the “husk” is collected during the hulling process. The husk may be further dried to ensure that the moisture and water activity is very low and collected as “husk cascara.”

The cascara may undergo further processing including sorting to remove any remaining parchment pieces and grading of the cascara. Physical, chemical and microbiological analyses may also be performed on the cascara.

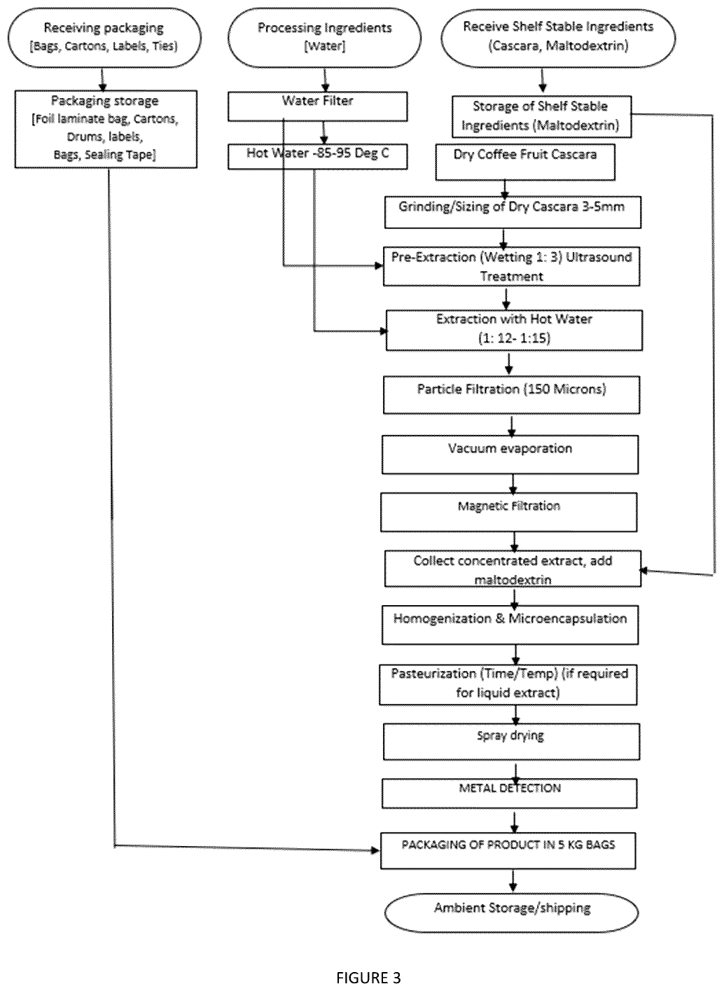

In yet another example, the method for making the soluble cascara powder includes further processing husk or pulped cascara. One example is shown in FIG. 3, which shows example processing steps that may be performed to prepare soluble cascara powder, in whole or in part (i.e. in some examples on certain steps are performed). After drying, the cascara may be ground. In one aspect the dry cascara is ground to a size of about 2-15 mm, for example, about 3-5 mm. Any grinding apparatus may be used to grind the cascara, including, without limitation a tea leaf grinder, a hammer mill or industrial roller grinders. The ground cascara may then be weighed and subjected to a pre-extraction step. The pre-extraction step may include sonication treatment of cascara material to enhance extraction of cascara solids. For example, during this pre-extraction step, the ground cascara may be soaked with water at a temperature of about 25-70° C., such as about 50° C. to form a cascara mixture having a cascara to water ratio of about 1:3-1:5. In one example, an ultrasonic horn is applied to a cascara mixture including ground cascara and a solvent such as water. The ultrasonic horn may have a power of about between about 300-600 W, such as about 500 W. The ultrasonic horn may be applied to the cascara mixture for a specified time, for example for about 30 minutes, about 25-35 minutes, about 15-45 minutes, or at least about 15, 30 or 45 minutes.

Following the pre-extraction step, the cascara mixture is then extracted with a solvent, for example with a heated solvent. In one example, the solvent used is water. The solvent, such as water, may be heated to a temperature of about 80-100° C., such as about 88-92° C. In some examples, there cascara to water ratio may be about 1:10-1:12. In some examples, the mixture is extracted for about 120 minutes to arrive at approximately 1500 kg of extract. Post-extraction the thin extract may be drawn off and progressively filtered with a final filtration, for example through a 100-150 micron filter and the liquid extract is collected.

Optionally, after the extraction and before filtration, the mixture may be undergo a solvent removal or dewatering process. For example, the cascara material may be mechanically pressed or squeezed. In other examples, the material may be centrifuged. In some examples, the material may undergo high pressure extraction via an extraction column. One or more of these steps may be performed in sequence, for example a high pressure extraction may be followed by centrifuge treatment. This may increase the amount of cascara solids removed via solvent (e.g. water) and thus increase the yield of cascara solids. In some examples, a solvent removal or dewatering process may also result in additional removal of pectin along with other cascara solids. Thus, in at least embodiments and applications where higher turbidity levels are not desired, there is no dewatering process, as such as process can increase turbidity. In some embodiments and applications, however, a dewatering process is performed as this will increase the solids yield of cascara. Use of a dewatering process can also increase color shade and/or intensity through removal of additional cascara solids.

After filtering, the extract may then be concentrated. In one example, the extract is concentrated using a vacuum evaporator. An operating temperature of about 50-90° C., such as about 70° C., and vacuum of about 70 cm Hg may be used to evaporate the remaining solvent from the extract. The evaporation may take place using a variety of known methods to the skilled artisan, including without limitation, using a flash evaporator. The evaporation process may be run on the extract until the extract reaches soluble solids content of about 25-30%. Pulling a high vacuum allows the water to flash off and siphon to a separate condenser chamber. For example, the total evaporation time may be between about 9-15 hours, such as about 12.5 hours. In one example, the evaporator batch input quantity may be 7 batches having a weight of about 200 kg and one batch having a weight of about 100 kg. The water evaporated per batch can be about 187 kg water for the 7 batches with an initial input quantity of 200 kg and about 95 kg for the initial batch of about 100 kg extract, resulting in a total concentrated extract output of about 96 kg following evaporation. The extract is concentrated to a soluble solids content of about 20-30 Brix or about 20-30% soluble solids. During this step, and under the conditions specified herein, the inventors have found that undesirable aromas are stripped away and the desirable aromas are enhanced. Without being bound by theory, the desirable aromas may be enhanced by a Maillard reaction occurring between the sugars and the amino acids in the concentrated extract, enabling the production of a palatable concentrated cascara extract product. Following the vacuum evaporation, the extract may be subjected to magnetic filtration prior to collection of the concentrated extract.

In one example, the concentrated extract may be used by itself in various food and beverage applications. The concentrated exact may be further refined using centrifugal separators to remove particulate matter and may be pasteurized through a suitable kill step process and packaged into bulk containers, pails, or bag-in-box containers and further tested for quality and food safety parameters such as color and microbiological parameters.

In another example, the concentrate extract may be microencapsulated with a carrier to further improve stability of the extract. In particular, a maltodextrin carrier may be added to the concentrated extract. For example, about 10 kg of maltodextrin carrier can be added to about 96 kg of concentrated liquid cascara extract. The carrier may be mixed with the extract. In one example, the carrier is added at a range of about 5-10% of the weight of the cascara, such as about 10%. The mixing speed used in one example is about 1900 rpm at less than about 70° C. Following the encapsulation of the concentrate extract, the mixture may be filtered to remove any undissolved carrier. The encapsulated concentrated cascara extract may then be dried, for example spray dried. The spray drying may have an inlet temperature of about 100-195° C., such as about 165° C. The encapsulated concentrated cascara extract may be spray dried to obtain a soluble cascara powder. In one example, the soluble cascara powder contains about 75-80% of coffee fruit solids and about 20-25% of a carrier such as maltodextrin. The final moisture of the soluble cascara powder may be about 1-7%, for example about 2-5%. The typical caffeine content of the soluble cascara product powder may be about 0.5-4% caffeine, and more particularly, about 1-2%. The polyphenol content of the soluble cascara powder may be about 0.5-2.0% polyphenols. In one example, the quantity of feed used in the spray drying process is about 106 kg with a feed rate of about 13 kg/hr. Further, the spray drier has an inlet temperature of about 165° C. and an outlet temperature of about 90° C. Additionally, the spray drier contains compressed air pressure of atomization of 1.8 bar. The inventors found that spray drying may be advantageous at least because it encapsulates and protects the bioactive components and improves the stability of these bioactive components contained in the concentrated extract, reduces the glass transition temperature and therefore reduces caking of the powder, and increases the dietary fiber content of the final soluble cascara product when encapsulated with a carrier such as inulin. Following spray drying, in this example the soluble cascara powder is collected and may be sieved to create more uniform powder particles. Moreover, the soluble cascara powder has a microbiological load of less than 50,000 CFU. .Additional testing may be performed including quality and food safety checks such as metal detection. In one aspect, the soluble cascara powder may be packaged in 5-10 kg bags for further, processing, distribution and/or testing.

The cascara extract has a high content of sugars and when spray dried can be a hygroscopic powder and not stable under ambient conditions with high relative humidity. Using a carrier selected from the group consisting of maltodextrin, inulin, cyclodextrin, gum arabic, or any other encapsulating agents or anti-caking agents during or after spray drying of the concentrated extract, for spray drying the concentrated cascara extract powder enables the powder to be stable under ambient and relative humidity <60%.

In aspects of this disclosure, the soluble cascara powder is derived from coffee cherries grown and harvested in and from various geographic regions and/or cherries from the same region but processed in different manners such that each respective group of cherries will result in cascara with different properties, e.g. a lower NTU, higher level of soluble solids, increased phenolic content, and/or increase content of a particular compounds (such as any of the compounds discussed herein, e.g. gallic acid, 4-CQA, etc.). The soluble cascara powders derived from the various sources and/or derived from different processing steps may differ in their compositional and sensory characteristics which enable the production of novel coffee fruit extracts that can be developed for specific applications, including, without limitation, novel food, beverage, and confectionary products as well as other comestibles. In one particular example, the use of a combination of soluble cascara powder derived from coffee cherries grown and harvested in Laos, Indonesia, Zambia, Tanzania and/or Peru are used in various proportions to provide desired aroma compounds to create a refreshing coffee fruit cascara beverage. In some examples, cascara obtained from different coffee fruits and/or via different processing steps may be combined into a blend, e.g. mixing two or more cascara extracts with different concentrations of one or more phenolic compounds and/or one or more sugar compound(s), different color characteristic(s), different turbidity levels, different bioactive properties, and/or difference(s) in the presence or absence of volatile compound(s) such as volatile compounds influencing taste and/or aroma.

In another example, combinations of powders derived from husk cascara and pulped cascara derived from coffee cherry fruit obtained from various geographic locations were developed, which also exhibited desired aroma compounds that resulted in a highly palatable food or beverage product. In another example, combinations of powders derived from husk cascara and pulped cascara derived from coffee cherry fruit from the same geographic locations were developed, which also exhibited desired characteristics. For example, using water in the pulping process may result in loss of sugar but high concentrations of polyphenols.

In another example, combinations of powders derived from coffee cherry fruit using different processes (e.g. one with a dewatering step and one without, which can result in low NTU values for the former but higher soluble solids and higher concentrations of specific compound(s) for the latter as discussed herein) from the same geographic locations were developed, which also exhibited desired characteristics and can result in novel characteristics of the combined composition, for example through use of combined powders, one with a low NTU value and another with relatively high solids levels, providing a unique total extract, e.g. one with a relatively low turbidity level despite the quantity of solids contained therein.

The components of the soluble cascara powder differ compared to cascara as shown in Table 1 below.

TABLE 1

| | Dry Coffee | | Coffee Fruit | |
|---|---|---|---|---|
| Parameter | Fruit Cascara | | Extract Powder | |
| Moisture | 5.00-9.29% | | 2.0-5.0% | |
| Ash | 6-8% | | 9.0-12.0% | |
| Protein | 7.5-12.0% | | 5.0-7.0% | |
| Fat | 0.76-1.4% | | <0.10% | |
| Trans-fat | <0.10% | | <0.10% | |
| Total carbohydrates | 68-72% | | 78-82% | |
| Total sugars | 3-10% | | 6.8 28% | |
| Glucose | 1.2-11.6% | | 1.6-9.4% | |
| Fructose | 2.0-16.8% | | 4.1-16.1% | |
| Sucrose | 0-0.5% | | 0-0.45% | |
| Total fiber | 30-50% | | 6.0-13.0% | |
| Potassium | 2900-3500 | mg/100 g | 3940-4810 | mg/100 g |
| Calcium | 285-350 | mg/100 g | 73-98 | mg/100 g |
| Iron | 3.5-9.0 | mg/10 g | 4.0-5.4 | mg/100 g |
| Sodium | 5.0-10 | mg/100 g | 11-24 | mg/100 g |
| Chlorogenic acid | 1.8-8.5 | mg/g | 0.9-1.1 | mg/g |
| Caffeine | 6.6-8.0 | mg/g | 8.0-9.0 | mg/g |
| p-Coumaric acid | 0.015-0.13 | mg/g | | |
| Protocatechuic acid | 2.3-3.4 | mg/g | 0.28-5.9 | mg/g |
| Rutin | 0.07-0.25 | mg/g | 0.025-0.10 | mg/g |
| Mangiferin | 0.80-3.3 | mg/g | 0.010-0.090 | mg/g |
| Gallic acid | 0.80-8.0 | mg/g | 0.030-2.4 | mg/g |

Moreover, the inventors found that the yield of the soluble cascara powders differed based on the location where the starting coffee cherry fruit was grown, harvested, method of processing and water usage during pulping of the cherries. The soluble solids inherently present in the coffee cherry fruit and the solids lost with the water contact during the pulping step had a significant influence on the solids level in the dry cascara. Dry cascara and soluble cascara powder differed in the level of total phenolics based on the variety, origin, and terroir of the coffee fruit. For example, the solids yield from the Indonesian coffee cherries was about 25-38%, such as about 35%, whereas the yield from the Laotian coffee cherries was about 39-48%, such as about 45%. In one example the ratio of the soluble cascara powder product from coffee cherry fruit derived from one geographic location and a second geographic location is between about 55:45 and about 65:35, or between about 10:90 and about 90:10, or about 25:75 and about 75:25. Similar ratios or other ratios may be used for cascara powder product obtained by coffee cheery fruit that is processed differently, e.g. some with a dewatering step and some without such as step.

In one example, the cascara powder is derived from coffee cherries grown and harvested in Indonesia from Coffea arabica. In another example, the cascara extract powder is derived from coffee cherries grown and harvested in Laos from Coffea arabica. Table 2 below illustrates the difference in sensory, analytical and microbial qualities of the soluble cascara powders originating from Indonesian and Laotian coffee cherries.

TABLE 2

| Origin | Indonesia | Laos |
|---|---|---|
| Color | Dark Brown | Light Brown |
| Moisture % | 5.5% | 5.5% |
| Particle size though 40 mesh | 100% | 100% |
| Caffeine | 0.9% | 0.9% |
| Total phenolic content (GAE mg/g) | 65 | 30 |
| Total plate count (CFU/g) | 10 | 60 |

In addition to the sensory, analytical and microbial qualities illustrated above, the soluble cascara powder exhibited differences in their respective nutritional values (per 100 g). In one example, the soluble cascara powder contained: 250-00 Calories, 15-26 mg sodium, 4000-5000 mg potassium, 70-90 g total carbohydrate, 9-13 g dietary fiber, 5-10 g sugar, 3-8 g protein, 85-100 mg calcium, 3-6 mg iron, 2-4 g moisture and 2-6 mcg vitamin D. In another example, the soluble cascara powder contained: 300-400 Calories, 8-14 mg sodium, 3000-4100 mg potassium, 70-90 g total carbohydrate, 5-8 g dietary fiber, 30-35 g sugar, 5-9 g protein, 60-80 mg calcium, 3-6 g moisture, and 0.2-0.9 mcg Vitamin D. An example of the soluble cascara powders derived from Laos and Indonesia exhibiting differing nutritional values (per 100 g) is illustrated in Table 3 below.

TABLE 3

| Origin | Indonesia | Laos |
|---|---|---|
| Calories | 340.9 | 345.4 |
| Sodium (mg) | 23.9 | 11.7 |
| Potassium (mg) | 4810 | 3940 |
| Total Carbohydrate (g) | 80.1 | 79.6 |
| Dietary Fiber (g) | 11.79 | 7.09 |
| Sugars (g) | 6.90 | 27.21 |
| Fructose | 4.18 | 16.1 |
| Glucose | 1.6 | 9.43 |
| Lactose | <0.25 | <0.25 |
| Maltose | 1.1 | 1.3 |
| Sucrose | <0.25 | 0.45 |
| Protein (g) | 5.12 | 6.75 |
| Calcium (mg) | 97.5 | 73.2 |
| Iron (mg) | 5.4 | 4.0 |
| Moisture (g) | 3.62 | 4.20 |
| Ash (g) | 11.19 | 9.41 |
| Vitamin D (mcg) | 3.75 | <0.55 |

As shown in Table 3 above, the amount of sugar and dietary fiber differs significantly between the soluble cascara powders derived from Indonesian and Laotian coffee cherries. This was unexpected due to their relative geographic proximity in comparison to other popular geographic regions for growing coffee such as Peru, Brazil, Tanzania, DRC, Zambia, etc.

Moreover, the soluble cascara powders contained higher than expected levels and differing levels of phenolic compounds. As shown in Table 4 below, the soluble cascara powder derived from Indonesian coffee cherries contained about 20 times more protocatechuic acid than the soluble cascara powder derived from Laotian coffee cherries. Similarly, the amount of gallic acid in the soluble cascara powder derived from Indonesian coffee cherries was about 70 times higher than the gallic acid found in the soluble cascara powder derived from the Laotian coffee cherries. For example, the gallic acid in Indonesian cascara powder may be about 1800-2500 ug/ug while the Laotian cascara powder may contain about 20-50 μg/g of gallic acid. Similarly, the Indonesian cascara powder may contain about 4000-6500 μg/g protocatechuic acid, whereas the Laotian cascara powder contains about 100-400 μg/g protocatechuic acid.

TABLE 4

| | Soluble Cascara | Soluble Cascara |
|---|---|---|
| Phenolic Compound | Powder - Laos | Powder - Indonesia |
| Caffeine (μg/g) | 8604 | 8123 |
| 5-CQA (μg/g) | 298 | 326 |
| 3-CQA (μg/g) | 153 | 69.9 |
| 4-CQA (μg/g) | 39.1 | 104 |
| 3,4-diCQA (μg/g) | 259 | 251 |
| 4,5-diCQA (μg/g) | ND | ND |
| Gallic Acid (μg/g) | 32.8 | 2415 |
| Protocatechuic acid (μg/g) | 285 | 5881 |
| Rutin (μg/g) | 25.6 | 101 |
| 3,5-diCQA (μg/g) | 257 | 248 |
| Mangiferin (μg/g) | 12.0 | 87.0 |
| Total Phenolic Content | 30.2 | 65.4 |
| (mg GAE/g) | | |

Further, the inventors have found that bioactive properties, including antioxidant and anti-inflammatory properties, may be related to the phenolic composition of the cascara from which the extracts were derived. As such, and without being bound by theory, it is expected that further research will confirm that the soluble cascara powder extracts prepared in accordance with aspects of this disclosure will have at least as high, if not higher bioactive properties than the cascaras from which they are derived.

Further testing has indicated that the cascara extracts of this disclosure result in desirable properties. For example, pulped cascara was obtained from coffee cherries from various geographic areas in accordance with this disclosure. The cascara samples were ground into a homogenous powder and then extracted twice of 100 mL of water at 85 degrees Celsius for 15 minutes, then the water extracts were centrifuged at 3220 g for seven minutes with an Eppendorf Centrifuge. The supernatants were collected in a 250 mL volumetric flask. A third extraction was performed with 40 mL of hot water, this time using an ultrasonic bath for 15 min followed by centrifugation at 3220 g for 10 min. The supernatant was filtered into the flask and the volume was adjusted with water to final volume of 250 mL Extracts were made in triplicate from each sample. Extractions were passed through Whatman No. 4 filter paper and then freeze dried to a powder. Powdered samples were dissolved in ultra-pure water (or cell medium for cell-culture assay) and analyzed as such after filtration with the Exapure 0.45 mm nylon filter. These samples were then tested by ABTA assay and ORAC assay.

For the ABTS chemical assays, conducted to determine the antioxidant capacity (single electron transfer activity) of coffee cascara extracts, radical ABTS [2,2′-azino-bis(3-ethylbenzothiazoline-6-sulfonic acid)] cations were generated by mixing ABTS (7 mM) with potassium persulfate (2.45 mM) in distilled water incubating in dark under room temperature for 12-16 hours. On the day of testing, the ABTS+working solution was diluted to reach an absorbance of 0.70±0.02. Into each well of the 96-well clear microplate, 20 μL of diluted sample extract or Trolox standard was added to 180 μL of ABTS working solution. After 6 min, absorbances were measured at a wavelength of 734 nm using a Multiskan Spectrum (Thermo Fischer Scientific, Vantaa, Finland). Measurements were made in triplicate. The ratio between the slopes of the regression equations for the coffee cascara or leaf tea extracts and the Trolox standard was defined as the antioxidant capacity of the tested samples. The results were expressed as μmol Trolox Equivalent (TE)/100 g of sample.

The antioxidant capacities (hydrogen atom transfer activity) of coffee cascara extracts were also assessed using the oxygen radical absorbance capacity fluorescein (ORAC) assay. Into each well of a black 96-well dark plate, 100 μEL of diluted sample extract or Trolox were mixed with 60 μEL of 200 nM fluorescein sodium salt. After incubating the plate to 37° C. in the dark, 40 μL of 60 mM AAPH was added to each well. Fluorescence intensities with 485 nm excitation and 527 nm emission were read every minute for 60 minutes in the Tecan Infinite M200 Pro (Tecan Austria GmbH; Männedorf, Switzerland) at 37° C. Measurements were performed in triplicates. Area-under-the-curve (AUC) was calculated based on Equation 1, and the antioxidant capacity of extracts was determined from the ratio between the regression equations slopes for extracts and Trolox. ORAC values were expressed as μmol Trolox Equivalent (TE)/100 g of sample.

$$Calculation of Area - Under - curve .$$

$$AUC = {\sum }_{n = 1}^{60} \frac{{f}_{1}}{{f}_{n}} = 1 + \frac{{f}_{2}}{{f}_{1}} + \frac{{f}_{3}}{{f}_{1}} + ⋯ + \frac{{f}_{59}}{{f}_{1}} + \frac{{f}_{60}}{{f}_{1}} \qquad Equation 1$$

$${f}_{n} : fluorescence intensity at time n .$$

Testing of prooxidant capacity analysis of cascara extracts (from pulped cascara) was also tested, where extract solutions were prepared as 1.25 mg sample obtained from methanol extraction to produce detectable amounts of hydrogen peroxide over a period of 24 h (04/24 h) in a cell culture medium. Since hydrogen peroxide is a product of auto-oxidation, the capacity of different samples to generate hydrogen peroxide this indicates relative prooxidant capacity.

The results from these tests are as follows:

| | | | H₂O₂ concentration |
|---|---|---|---|
| Extract | ORAC Results | ABTS Results | generated (uM |
| Material | (μmol Trolox/ | (μmol Trolox/ | hydrogen peroxide |
| Origin | 100 g sample) | 100 g sample) | generated in 24 h) |
| Laos | 17392 | 7395 | 1.8 |
| Laos | 22378 | 5996 | 5 |
| Laos | 30493 | 9303 | 2 |
| Laos | 26296 | 7015 | 5.6 |
| Laos | 28966 | 6499 | 2.5 |
| Brazil | 33874 | 8639 | 1.5 |
| Bolivia | 16048 | 6090 | 2.8 |
| Peru | 28944 | 8810 | 4.1 |
| Peru | 25614 | 15969 | 1.6 |
| Indonesia | 25249 | 18325 | 3.2 |
| Tanzania | 13281 | 10487 | 1.2 |
| Zambia | 24358 | 20828 | 2 |

As demonstrated above, all cascara extracts prepared by methods of this disclosure result in generated auto-oxidation product (e.g., 1.2-5.6 μM of hydrogen peroxide) and thus have a prooxidant activity level. This provides advantageous properties as plant phenolics must be capable of undergoing autoxidation to produce hydrogen peroxide to have antioxidant activity. Thus, cascara extracts prepared by methods of this disclosure, all demonstrate antioxidant activity, e.g. exhibited a capacity to H₂O₂ in culture media. This activity may then trigger intercellular antioxidant enzyme production or upregulation and can provide an important chemo-preventative mechanism for preparing cells for an onset of oxidative stress. Cascara extracts prepared by methods of this disclosure, in at least some examples, contain phytochemicals that represent secondary metabolites with noted antioxidant activities that complement the intracellular response to prepare for oxidative stress.

The positive ORAC and ABTS results indicate the cascara extracts prepared by methods of this disclosure may provide the capacity to scavenge radicals, such as scavenging peroxyl radicals, and thus provide antioxidant activity though at least this manner as well. In some examples, the cascara extract (as tested above and measured via an ORAC assay) has a hydrogen atom transfer activity level of at least about 13,000 μmol Trollox/100 g sample or more, or about 14,000 or more, about 15,000 or more, about 16,000 or more, about 18,000 or more, about 20,000 or more, about 22,000 or more, about 24,000 or more, about 26,000 or more, about 28,000 or more, about 30,000 or more, about 32,000 or more, or about 34000 μmol Trolox/100 g sample or more, while in some examples the extract has a level of about 13,000-34,000, about 20,000-34000, about 18,000-32,000, or about 18,000-26,000 μmol Trolox/100 g sample. In some examples, the cascara extract (as tested above and measured via an ABTS assay) has a single electron transfer activity level of about 6,000 μmol Trolox/100 g sample or more, or about 8,000 or more, about 10,000 or more, about 12,000 or more, about 14,000 or more, about 16,000 or more, about 18,000 or more, about 20,000 or more, or about 21,000 μmol Trolox/100 g sample or more, while in some examples the extract has a level of about 6,000-21,000, about 10,000-20,000, about 6,000-12,000, or about 10,000-21,000 μmol Trolox/100 g sample. In some examples, the cascara powder extract has a hydrogen atom transfer activity level of 13,000-34,000 μmol Trolox/100 g sample as measured by a ORAC assay. In some examples, the cascara powder extract has a single electron transfer activity level of 6,000-21,000 μmol Trolox/100 g sample as measured by a ABTS assay. In some examples, the cascara powder extract has a prooxidant activity level such that a 1.25 mg/mL sample produces 1.2-5.6 μM of hydrogen peroxide over 24 hours.

Also unexpected were the sensory and nutritional characteristics observed when blending the soluble cascara powders derived from coffee cherries grown and harvested in different geographical locations. As an example, the soluble cascara powders derived from Indonesian and Laotian derived coffee cherries when blended exhibited the characteristics identified in Table 5 below and the nutritional characteristics set forth in Table 6 below.

TABLE 5

| Color | Brown |
|---|---|
| Moisture % | 5.5% |
| Particle size though 40 mesh | 100% |
| Caffeine | 0.9% |
| Total phenolic content | 47 |
| (GAE mg/g) | |
| Total plate count (CFU/g) | 60 |

TABLE 6

| | Blend of Indonesian and |
|---|---|
| Per 100 g of the Blend | Laotian Cascara Powders |
| Calories | 345 kcal |
| Sodium (mg) | 17.8 |
| Potassium (mg) | 4375 |
| Total Carbohydrate (g) | 80.0 |
| Dietary Fiber (g) | 9.40 |
| Sugars (g) | 17.0 |
| Protein (g) | 6.0 |
| Calcium (mg) | 85.0 |
| Iron (mg) | 4.7 |
| Moisture | 4.2 |
| Ash | 10.3 |
| Vitamin D (mcg) | 2.0 |

The blend of Indonesian to Laotian cascara powder blend was between about 0.95:1.05 and about 1.05:0.95, such as about 1:1; however, it is contemplated that a range of ratios, including about 10% and 90% of each powder or about 20% and 80% of each powder, or about 30% and 70% of each powder, or about 40% and 60% of each powder, may be used in accordance with this disclosure. Further, these ratios may apply to cascara powders derived from coffee cherries grown and harvested in other geographic locations such as Zambia, Laos, Indonesia, Tanzania, Peru, DRC, and other locations in the bean belt, and/or different cascara extract materials, including those based on coffee cherries from different regions and/or processed via different manner, e.g. with v. without dewatering, husk v. pulped cascara, and/or different amounts of water in process for example during the pulping process.

In some embodiments, a blend of two or more cascara materials is provided. The distinct cascara materials blended together may have different geographic origins, may be processed differently, e.g. may have the same geographic origin but one cascara source is husk cascara from that region while another cascara source is pulp cascara from that region and/or one source may use different amounts of water in processing than another source and/or one source may have a dewatering step in process while another source does not have any dewatering step or uses a different dewatering step (e.g. pressing instead of centrifuge treatment, or a lower intensity and/or time duration of the dewatering treatment that will influence the extent of removed solids). Given the benefit of this disclosure, an artisan will be able to select starting materials and/or processing conditions to provide a variety of cascara extract traits, and can use various extract blends to further impact the composition qualities. Blends may include any cascara materials of this disclosure, including blends of two or more cascara sources, three or more, or four or more. As representative examples, a blend may include two cascara extracts with different characteristics, for example one extract with relatively intense color absorbance and a second extract with relatively weak color absorbance, one extract with relatively low turbidity (e.g. under about 20, 18, 16, 15, 14, or 13 NTU) and another with a higher turbidity, or a first extract with a relatively strong color absorbance and a second extract with relatively weak color absorbance.

In another example, coffee cherries grown and harvested in Indonesia, Zambia, Tanzania and the Democratic Republic of Congo are further processed in accordance with this disclosure. Surprisingly, despite the coffee variety and growth at a similar latitude, sometimes referred to as the “bean belt,” the powders exhibited different physical and compositional properties. Some of these observations for extracts from coffee cherries derived from these regions are shown in the following Table 7. For purposes of displaying the data below, averaged values were used.

TABLE 7

| | Laos | Peru | Indonesia | Zambia | Tanzania | DRC |
|---|---|---|---|---|---|---|
| % Moisture | 5.03 | 7.05 | 7.95 | 6.06 | 7.09 | 6.25 |
| Water activity a_{w} @ 25° C. | 0.41 | 0.46 | 0.53 | 0.47 | 0.410 | 0.450 |
| Brix of extracted solution | 1.36 | 1.34 | 1.15 | 1.34 | 1.57 | 1.30 |
| (10 g in 350 ml water) | | | | | | |
| Total Solids | 1.37% | 1.32% | 1.10% | 1.39% | 1.59% | 1.20% |
| pH | 4.78 | 3.55 | 3.74 | 4.59 | 4.49 | 4.80 |
| Acidity (ml of 0.1N NaOH) | 2.61 | 4.31 | 3.85 | 1.81 | 1.86 | 1.05 |
| Caffeine % | 0.87 | 0.65 | 0.71 | 0.77 | 0.593 | 0.950 |

In an example, a cascara extract has the following characteristics: moisture of about 3.9-6.1%, water activity at 25° C. of about 0.30-0.50, Brix of about 1.1-1.5, total solids of about 1.1-1.6%, pH of about 4.5-5.1, acidity (ml of 0.1 N NaOH) of about 1.7-4.0 and caffeine content of about 0.8-0.9%. In another example, the cascara extract has the following characteristics: moisture of about 3.3-10.8%, water activity at 25° C. of about 0.3-0.6, Brix of about 1.2-1.5, total solids of about 1.2-1.5%, pH of about 3.4-3.7, acidity (ml of 0.1 N NaOH) of about 3.0-5.6 and caffeine content of about 0.6-0.7%. In another example, the cascara extract has the following characteristics: moisture of about 4.4-11.9%, water activity at 25° C. of about 0.3-0.7, Brix of about 0.9-1.4, total solids of about 0.9-1.4%, pH of about 3.7-3.9, acidity (ml of 0.1 N NaOH) of about 3.4-4.3 and caffeine content of about 0.6-0.8%. In yet another example, the cascara extract has the following characteristics: moisture of about, 5.5-6.6% water activity at 25° C. of about 0.44-0.51, Brix of about 1.3-1.4, total solids of about 1.3-1.5%, pH of about 4.4-4.8, acidity (ml of 0.1 N NaOH) of about 1.8-1.9, and caffeine content of about 0.7-0.8%. As a further example, the cascara extract has the following characteristics: moisture of about, 6.9-7.5% water activity at 25° C. of about 0.40-0.43, Brix of about 1.5-1.7, total solids of about 1.2-1.7%, pH of about 4.3-4.5, acidity (ml of 0.1 N NaOH) of about 1.7-1.9, and caffeine content of about 0.4-0.6%. In another example, the cascara extract has the following characteristics: moisture of about 6.1-7.1% water activity at 25° C. of about 0.43-0.53, Brix of about 1.2-1.4, total solids of about 0.9-1.5%, pH of about 4.7-4.9, acidity (ml of 0.1 N NaOH) of about 1.0-1.2, and caffeine content of about 0.8-1%.

The inventors also discovered differences among the soluble cascara powders derived from coffee cherries grown and harvested in different geographic locations, as well as in cascara powders that were processed differently during preparation of the cascara extract. These differences identified among the coffee cherries included varying moisture, water activity, brix, total solids, pH, aroma, glass transition temperature, acidity and caffeine. The difference in the total solids was due to the differences in the soluble sugars and types of sugars present in the cherries, pulped versus husk cascara, water used during pulping, and the relative ratio of polyphenols and sugars present in the coffee fruit.

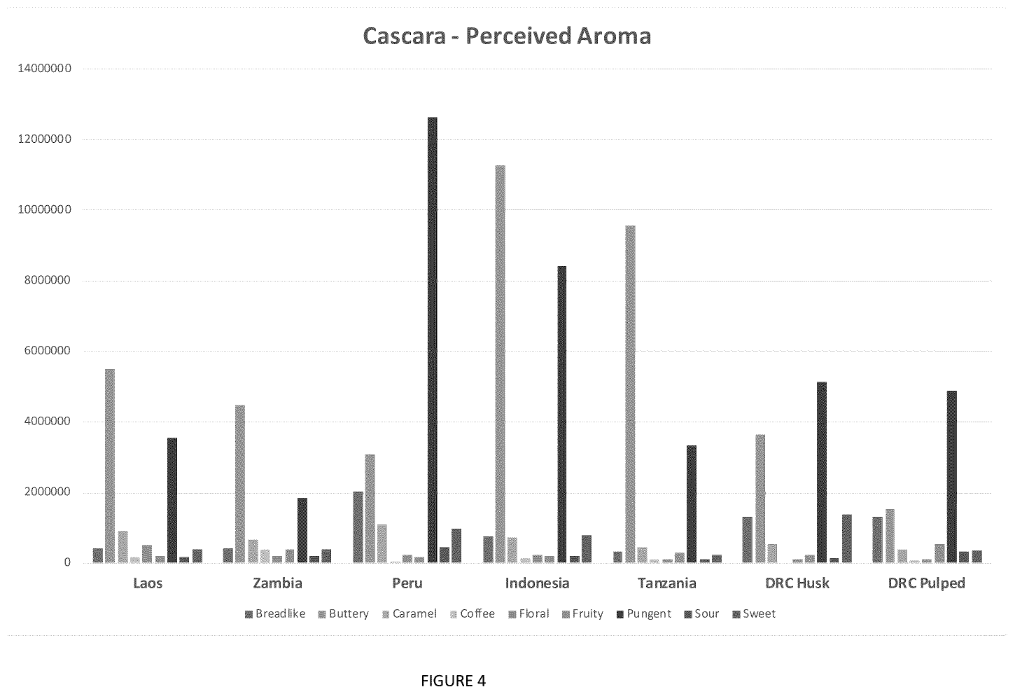

Further, the aromas associated with the soluble cascara powder extracts derived from coffee cherries grown and harvested from the different geographic regions differed significantly. Referring to FIG. 4, the perceived aroma was calculated using gas chromatography mass spectroscopy to identify the primary chemical compounds contained in the various cascaras. The cascara samples for Laos, Zambia, Peru, Indonesia, DRC, and Tanzania were prepared by grinding and then enclosing them in a vial to capture the aroma from the powder in the head space of the vial. Solid Phase Micro Extraction (SPME) technique was used to adsorb the aroma from the powders on to a fiber and then was desorbed by injection into a gas chromatograph at a high temperature. The gas chromatograph separated the mixture of the aroma molecules which were further detected, identified and quantified by a mass spectrometer. The chemical classes of each of these components were identified (i.e., ester, ketone, aldehyde, furan hydrocarbon, ketol, etc.). The perceived aroma of each of these components were then identified based on the relevant scientific literature, including the perceived aroma corresponding to each chemical class (Pua et al. (2021), “A systematic study of key odorants, non-volatile compounds, and antioxidant capacity of cascara (dried Coffea arabica pulp)” LWT—Food Science and Technology 138, 110630.

As shown in FIG. 4, the perceived aromas of breadlike, butter, caramel, coffee, floral, fruity, pungent, sour, and sweet vary significantly across cascara derived from Laos, Zambia, Peru, Indonesia, DRC, and Tanzania. Surprisingly, despite the fact that these locations are all located at a relatively similar latitude the perceived aromas of the various cascaras differed significantly. In particular, the cascara derived from Peruvian and Indonesian coffee cherries exhibited a very pungent perceived aroma compared to the cascaras derived from Laotian, Zambian and Tanzanian coffee cherries. The Peruvian derived cascara also exhibited more intense floral perceived aroma compared to the Laotian, Zambian, Indonesian, DRC, and Tanzanian derived cascaras.

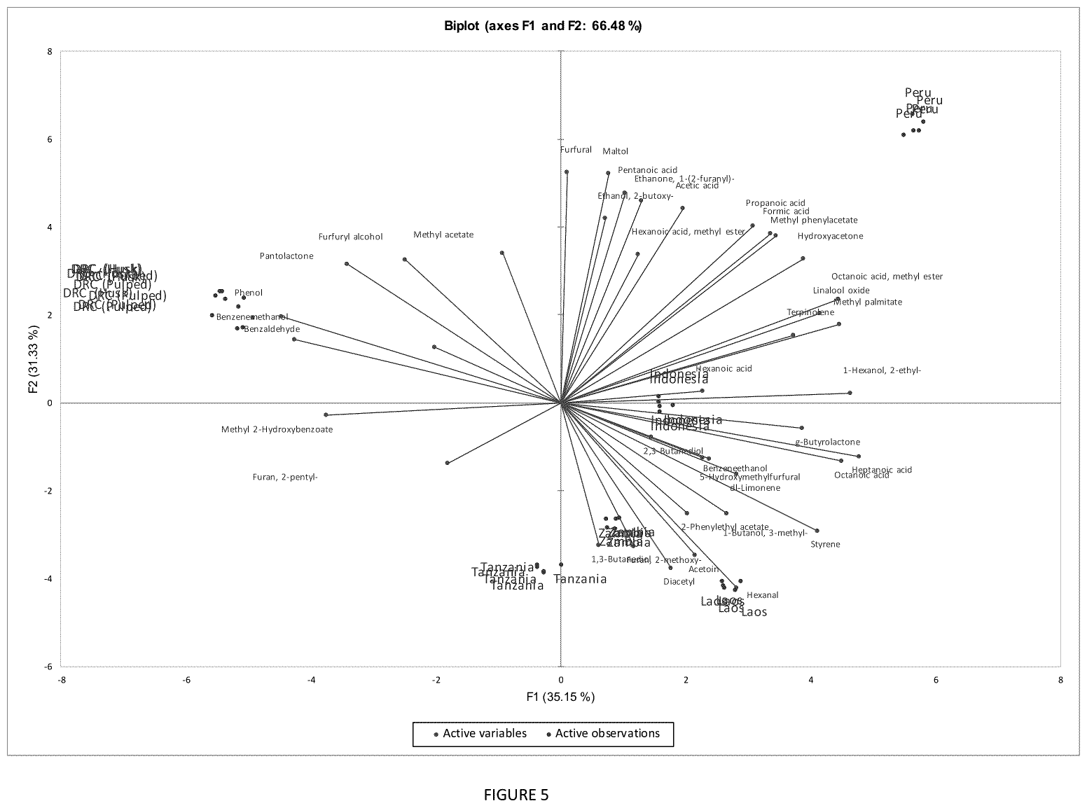

FIG. 5 is a biplot of the results contained in FIG. 4. More specifically, FIG. 4 further illustrates the perceived aromas on a biplot, taking the six variables—the six origins (Laos, Zambia, Indonesia, Peru, DRC, and Tanzania) and plotting based on presence of the various aroma compounds for each of the origins. As illustrated in FIG. 5, cascaras derived from Peruvian and Indonesian coffee cherries exhibited a similarity in their respective esters and perceived aromas despite the geographic distance between these two locations. On the other hand, the cascaras derived from Laos, Tanzanian, and Zambia were found to be very similar with respect to their chemical compounds, despite their geographic distance between the two locations. The husk and pulped cascaras derived from DRC coffee cherries demonstrated a high amount of benzenemethanol which is associated with preferred floral and fruity aroma compounds. In other words, FIGS. 4 and 5 further demonstrate and reaffirm the diversity of the cascaras derived from the various geographic locations.

The soluble cascara powders made in accordance with aspects of this disclosure may be used in a variety of applications. Table 8 below provides exemplary applications, along with serving sizes and proposed quantity of the soluble cascara powder used in the food or beverage.

TABLE 8

| | | | Quantity of | |
|---|---|---|---|---|
| | | | Soluble Cascara | |
| | | Serving | Powder Used | |
| Food Type | Description of Food | Size | (mg/serving) | |
| Ready to Drink | Still or carbonated | 355 ml | 6.6 | g |
| Beverages (RTD) | flavored or | | | |
| | unflavored ready to | | | |
| | drink beverages | | | |
| Flavored Syrups | Syrup which can be | 300 ml | 5500 | mg |
| | reconstituted to make | | | |
| | beverages in food | | | |
| | service channels | | | |
| Powdered beverage | Powder beverage | 250 ml | 4500 | mg |
| mixes/blends with | blends which can be | | | |
| or without diary | reconstituted with hot | | | |
| or non-dairy | water, cold water or | | | |
| creamer | sparkling water | | | |

For the example applications of Table 8, in some embodiments cascara powders that provide a turbidity of 100 NTU or less (at 0.3% wt) are used. In certain beverage embodiments, the cascara product (whether a blend or single extract) is present in an amount of about 0.1-10% by weight of the beverage, or about 0.5-2%, or about 0.75-1.5%, or about 1.5-2%. For example, a beverage may have 0.8% by weight of a cascara extract, of which 0.6% is from the cascara is 0.2% is from a carrier like maltodextrin. As demonstrated here, the carrier may be present in an about of about 20-30% by weight of the cascara product.

Additional proposed uses of the soluble cascara powder include adding 1.8 g of the soluble cascara powder per 100 ml of beverage which translated to about 1.35 g/100 g of coffee fruit solids This is equivalent to using 3.5 g of dried coffee fruit per 100 ml water. In another example, 9 g of soluble cascara powder is added to 100 g of syrup. Forty-two grams (42 g) of syrup will be used to make 300 ml of coffee fruit beverage, which translates to 1.26 g/100 ml of coffee fruit solids. This is equivalent of using 3.6 g of dried coffee fruit per 100 ml of water. In yet another example, 4.5 g of soluble cascara powder per 20 g of beverage powder mix is used. 20 g of powder will be used to make 250 ml of beverage which translates to 1.35 g/100 ml of coffee fruit solids. This is equivalent to use of 3.5 g of dried coffee fruit per 100 ml of water.

In one aspect, the disclosure relates to an aqueous extract of coffee fruit cascara which can be utilized as a beverage and food ingredient at a usage level equivalent to the levels approved by the European Food Safety Agency. In particular, the approved level of use of cascara in a liquid is an infusion of 4 g of cascara /100 g of water. The approved usage level requires a highly palatable quality of coffee fruit cascara, which is standardized for caffeine, chlorogenic acids, and phenolic acids. The cascara extract is further devoid of a cooked or stewed tea taste or aroma.

In another example, the soluble cascara powders may be used in variety of food and beverage applications, including, without limitation, cookies, confections (including hard boiled candy), ice cream, spreads or jams, cereal, kombucha, balsamic vinegar, marinades, and dry mixes (for example, cappuccino dry mixes). In one example, the soluble cascara powder will be used in a range of about 3.0-6.6 g per 12 oz. beverage, such as, 6.6 g soluble cascara powder per 12 oz. (355 ml) water, which is equivalent to infusion of 3.4 g of dry cascara per 100 ml of RTD beverage.

Processing cascara material (e.g. pulped or husk with a dewatering step, or without a dewatering step, during processing and preparation of the extract may result in differences in extract properties, even when the source of the raw material is identical. In an example, cascara from Indonesia was used to prepare a cascara extract where processes was identical except for the fact that for samples underwent a dewatering step during processing and some did not.

For the samples prepared with a dewatering step, cascara was pre-extracted by wetting (1:3 ratio cascara to water) in a tank and ultrasonic treatment was applied. This presoaked cascara was then extracted with hot water at 85-95 degrees Celsius (1:12 ratio cascara to water). The extract was filtered and then the spent cascara was placed in a screw press to dewater the spent cascara and extract an additional quantity of soluble solids. As demonstrated below, such dewatering/pressing increases the quantity of soluble solids and other desirable compounds. But can also lead to additional extraction of larger molecular weight pectin from cascara, which increases turbidity, as also demonstrated below.

For the samples prepared without a dewatering step, cascara was loaded to a basket and directly immersed into a tank of hot water at 85-95 degrees Celsius that was pumped into the tank at 1:15 cascara:water ratio and ultrasonic treatment was applied. After extraction, the basket was taken out of the tank and the extract was drained. No further dewatering step was used to extract more soluble solids from the spent cascara. In this process, the extraction of the larger molecular weight pectin from cascara was avoided, resulting in relatively lowered turbidity.

After extraction of the cascara material, the samples had the following properties, where color absorbance was measured after centrifuging the samples.

TABLE 9

| | Indonesia | Indonesia | Indonesia | Indonesia |
|---|---|---|---|---|
| | Cascara | Cascara | Cascara | Cascara |
| | prepared | prepared | prepared | prepared |
| | without | without | with | with |
| | dewa- | dewa- | dewa- | dewa- |
| Material | tering | tering | tering | tering |
| Turbidity | 15.8 | 13.8 | 337 | 352 |
| (NTU at 0.3% | | | | |
| concentration) | | | | |
| Color | 0.220 | 0.216 | 0.221 | 0.221 |
| Absorbance @ | | | | |
| 560 nm | | | | |
| % Solids Extracted | 31.5 | 32.6 | 36.2 | 36.2 |
| 5-CQA μg/g | 625 | 616 | 825 | 836 |
| 3-CQA μg/g | 7084 | 6425 | 7810 | 7396 |
| 4-CQA μg/g | 914 | 859 | 1145 | 1025 |
| 3,4-diCQA μg/g | 360 | 319 | 342 | 339 |
| 4,5-diCQA μg/g | 140 | 128 | 174 | 157 |
| 3,5-diCQA μg/g | 328 | 300 | 314 | 289 |
| Gallic acid μg/g | 993 | 1045 | 1880 | 1663 |
| Procatechuric | 13244 | 14676 | 14184 | 15171 |
| acid μg/g | | | | |
| Rutin μg/g | 274 | 234 | 285 | 275 |
| Trigonelline μg/g | 13394 | 9339 | 13539 | 14407 |
| Caffeine μg/g | 11614 | 11248 | 9593 | 11583 |
| Mangiferin μg/g | 96.4 | 78.1 | 133 | 101 |
| Isomangiferin μg/g | 20.4 | 15.6 | 21.8 | 20.3 |
| Total CQA μg/g | 9449 | 8647 | 10610 | 10042 |
| Total Bioactives μg/g | 49085 | 45284 | 50245 | 53264 |
| Total w/o | 24077 | 24697 | 27114 | 27274 |
| Caffiene and | | | | |
| Trigonelline μg/g | | | | |
| Total Phenolics mg | 83 | 79 | 87 | 84 |
| GAE/g | | | | |

As demonstrated by these examples, performing example methods of this disclosure can allow one to influence the resulting characteristics of the cascara, for example through use of using, or intentionally not using, a dewatering step. As demonstrated by these examples, the compositional values of an otherwise equivalent composition prepared by an otherwise equivalent process, except for the use of dewatering, may be different, for example through use of dewatering a cascara extract may have % solids at least 4% higher (or about 3-4% higher), compared to an otherwise equivalent material from the same coffee cherries. Similarly, use of a dewatering step in accordance with this disclosure may result in the following increased concentrations: 5-CQA—about 200 μg/g or more above baseline level or about 200-220 μg/g above baseline level; 4-CQA—about 100 μg/g or more above baseline level or about 200 μg/g or more above baseline level or about 300 μg/g or more above baseline level, or about 100-300 μg/g above baseline level; 3-CQA—about 300 μg/g or more above baseline level or about 600 μg/g or more above baseline level or about 800 μg/g or more above baseline level, or about 1400 μg/g or more above baseline level, or about 300-1400 μg/g above baseline level or about or about 300-600 μg/g above baseline level; 4,5-diCQA—about 20 μg/g or more above baseline level; 3,5-diCQA—about 20 μg/g or more above baseline level; gallic acid—about 600 μg/g or more above baseline level, about 800 μg/g or more above baseline level, bout 900 μg/g or more above baseline level, or about 600-800 or about 600-900 μg/g above baseline level; mangiferin—about 5 μg/g or more above baseline level, or about 20 μg/g or more above baseline level, or about 50 μg/g or more above baseline level, or about 5-50 μg/g above baseline level; total CQA—about 500 μg/g or more above baseline level, about 1100 μg/g or more above baseline level, about 1400 μg/g or more above baseline level, or about 2000 μg/g or more above baseline level, or about 500-2000 or about 1100-1400 or about 1100-2000 or about 1400-2000 μg/g above baseline level; total bioactives—about 5000 μg/g or more above baseline level, about 8000 μg/g or more above baseline level, or about 5000-8000 above baseline level.

As demonstrated by these examples, liquid compositions including the cascara materials of this disclosure may have a NTU (at 0.3% concentration) of about 16 or less, or about 14 or less. As illustrated and demonstrated by these representative examples, cascara materials of this disclosure may a concentration of 5-CQA of about 615 μg/g or more, or about 825 μg/g or more, a concentration of 3-CQA of about 6400, 7100, 7400, or 7800 μg/g or more, a concentration of 4-CQA of about 860, 915, 1025, 1150 μg/g or more, a concentration of gallic acid of about 1000, 1050, 1650, or 1880 μg/g or more, a concentration of total CQA of about 8650, 9450, 10050, or 10610 μg/g or more, a concentration of total bioactives of about 49000, 45000, 50000, or 53000 μg/g or more, and/or a total phenolics content of about 79, 83, 84, or 87 mg GAE/g or more. In some examples, the cascara has an amount of one or more above noted compounds that is at least any of the values noted above.

Other example compositions prepared without dewatering from the same raw material had NTU levels (based on a 0.3% composition) of 14.1, 13.9, 14.3, 12.4, 13.8 and 16.4, along with corresponding % solids of 31.4, 31.6, 31.3, 29.8, 32.1 and 32.8 respectively. Other example compositions prepared without dewatering from Laos raw material had NTU levels (based on a 0.3% composition) of 84.6, 81.9 and 108, along with corresponding % solids of 32.5, 32.0, and 36.0, respectively. As demonstrated by this example data, preparation with dewatering may result in higher extraction of solids, compared to an equivalent process on an equivalent cascara source. This, in turn, may result in higher turbidity, as higher levels of pectin may also be extracted and this can strongly impact the resulting turbidity of a solution with the solids. The higher solids can also cause relative increased amounts of color intensity, and compound levels such as phenolics and/or CQA levels.

Processing coffee cherries into pulped cascara or husk cascara may result in differences in cascara extract properties, even when the source of the raw material is identical. In an example, cascara from the Democratic Republic of Congo was processed into both pulped cascara, where water was present during processing, and husk cascara, where water was not used during processing. No dewatering step was used in preparation of the extract. After extraction of the cascara material, the samples had the following properties.

| | Turbidity | Color | % |
|---|---|---|---|
| | (NTU at 0.3% | Absorbance | Solids |
| Material | concentration) | @ 560 nm | Extracted |
| DRC Pulped | 24.8 | 0.155 | 31.7 |
| Cascara | | | |
| DRC Husk Cascara | 17.6 | 0.083 | 33.9 |

As demonstrated by this example data, cascara material with the same properties may result in extracts with different properties and compositional traits when processed differently.

Traits of other representative examples are noted below.

| | Indonesia | Guatemala | Peru | Zambia |
|---|---|---|---|---|
| | Cascara | Cascara | Cascara | Cascara |
| | prepared | prepared | prepared | prepared |
| | without | without | without | without |
| | dewa- | dewa- | dewa- | dewa- |
| Material | tering | tering | tering | tering |
| Turbidity | 24.2 | 21.7 | 13.6 | 18.0 |
| (NTU at 0.3% | | | | |
| concentration) | | | | |
| Color | 0.214 | 0.173 | 0.098 | 0.074 |
| Absorbance @ | | | | |
| 560 nm | | | | |
| % Solids Extracted | 30.3 | 36.3 | 41.9 | 42.0 |
| 5-CQA μg/g | 474 | 53.7 | 72.2 | 737 |
| 3-CQA μg/g | 7843 | 8275 | 2507 | 12910 |
| 4-CQA μg/g | 619 | 19.8 | 114 | 1058 |
| 3,4-diCQA μg/g | 546 | 55.5 | 20.7 | 1143 |
| 4,5-diCQA μg/g | 105 | 11.5 | 20.1 | 132 |
| 3,5-diCQA μg/g | 317 | 6.83 | 35.2 | 801 |
| Gallic acid μg/g | 1163 | 191 | 73.3 | 20.3 |
| Procatechuric | 13476 | 2598 | 2853 | 193 |
| acid μg/g | | | | |
| Rutin μg/g | 368 | 25.3 | 146 | 296 |
| Trigonelline μg/g | 14664 | 21591 | 13431 | 17820 |
| Caffeine μg/g | 12150 | 12642 | 10586 | 14408 |
| Mangiferin μg/g | 157 | 42.4 | 46.1 | 32.9 |
| Isomangiferin μg/g | 19.6 | 0 | 0 | 0 |
| Total CQA μg/g | 9905 | 8422 | 2769 | 16782 |
| Total Bioactives μg/g | 51902 | 45511 | 29904 | 49552 |
| Total w/o | 25088 | 11278 | 5887 | 17324 |
| Caffiene and | | | | |
| Trigonelline μg/g | | | | |
| Total Phenolics | 82 | 38 | 34 | 42 |
| mg GAE/g | | | | |

As demonstrated by these examples, performing example methods of this disclosure can allow one to influence the resulting characteristics of the cascara, and example cascara extracts can have total phenolic content of about 30, 40, 50 or 80 or more mg GAE/g, a total bioactives content of about 30000, 45000, or 50000 or more μg/g, and a total CQA content of about 3000, 8000, 10000, or 17000 or more μg/g, and other compound concentrations of at least the example amounts noted above.

Volatile profiles of example cascara extracts, prepared without a dewatering step, are below.

| | Indonesia | Guatemala | Peru | Zambia |
|---|---|---|---|---|
| | Cascara | Cascara | Cascara | Cascara |
| | prepared | prepared | prepared | prepared |
| | without | without | without | without |
| | dewa- | dewa- | dewa- | dewa- |
| Compound | tering | tering | tering | tering |
| Benzene, methyl- | 72843 | 55898 | 65279 | 65697 |
| Dimethyl disulfide | 8912 | 12059 | 9059 | 9019 |
| Hexanal | 20015 | 24501 | 33149 | 15905 |
| dl-Limonene | 21827 | 20834 | 26085 | 24123 |
| Acetic acid | 2200033 | 666496 | 415089 | 443725 |
| Furfural | 398736 | 440876 | 675986 | 232743 |
| Ethanone, 1-(2- | 13881 | 10193 | 16848 | 4846 |
| furanyl)- | | | | |
| 5 Methyl furfural | 26958 | 19804 | 28833 | 19335 |
| Butyrolactone | 41604 | 40953 | 17536 | 15348 |
| Phenylacetaldehyde | 35963 | 43181 | 51556 | 27387 |
| Furfural alcohol | 15904 | 6659 | 8512 | 5191 |
| Benzenemethanol | 17955 | 8319 | 5342 | 44436 |
| Benzeneethanol | 21376 | 15004 | 12985 | 8725 |
| Ethanone, 1-(1H- | 11249 | 4940 | 6903 | 16639 |
| pyrrol-2-yl)- | | | | |
| Pyrrole-2- | 31784 | 27311 | 23921 | 12234 |
| carboxaldehyde | | | | |
| Nonanoic acid | 16987 | 15429 | 14206 | 18393 |

As demonstrated by these examples, performing example methods of this disclosure can provide example cascara extracts with compound concentrations of at least the example amounts noted above.

The present disclosure, above and in the accompanying drawings, is in reference to a variety of examples. The purpose served by the disclosure, however, is to provide examples but such examples should not to limit the scope of the invention. One skilled in the relevant art will recognize, given the benefit of this disclosure, that numerous variations and modifications may be made to the examples described above without departing from the scope of the present invention.

What is claimed is:

1. A soluble cascara powder product comprising:
a first soluble cascara powder derived from a first coffee cherry fruit;
wherein the first coffee cherry fruit has a soluble solids content of at least 12%;
wherein the first coffee cherry fruit has been subject to processing comprising the steps of: wet pulping to separate the first coffee fruit from coffee beans, drying the separated first coffee fruit to a water activity at 25° C. of between 0.3-0.65, extracting dry cascara using pre-soaking, and extracting cascara with an extraction solvent to form a first cascara extract, concentrating the first cascara extract to a soluble solids content of 20-30% to form a first concentrated extract, encapsulating the first concentrated extract with a carrier and spray drying the first concentrated extract; and
wherein the first soluble cascara powder comprises total phenolics in an amount of 55-70 mg GAE/g; and
wherein the first soluble cascara powder comprises 0.5-1.2% caffeine;
wherein the first soluble cascara powder comprises 9-13 g dietary fiber per 100 g;
wherein the first soluble cascara powder comprises 5-10 g sugar per 100 g;
a second soluble cascara powder derived from a second coffee cherry fruit;
wherein the second coffee cherry fruit has a soluble solids content of at least 12%;
wherein the second coffee cherry fruit has been subject to processing comprising the steps of: wet pulping, drying to a water activity at 25° C. of between 0.3-0.65, extracting dry cascara using pre-soaking, and extracting cascara with the extraction solvent to form a second cascara extract, concentrating the second cascara extract to a soluble solids content of 20-30% to form a second concentrated extract, encapsulating the second concentrated extract with a carrier and spray drying the second concentrated extract to form a second soluble cascara powder;
wherein the second soluble cascara powder comprises total phenolic content of 20-35 mg GAE/g; and
wherein the second soluble cascara powder comprises 0.5-1.2% caffeine;
wherein the second soluble cascara powder comprises 5-8 g dietary fiber per 100 g;
wherein the second soluble cascara powder comprises 20-35 g sugar per 100 g;
wherein the soluble cascara powder product comprises a blend of the first soluble cascara powder and the second soluble cascara powder to obtain a soluble cascara powder product comprising caffeine in an amount of 0.5-2.0%, a total phenolic content of 30-55 mg GAE/g per 100 g, dietary fiber of 5-12 g per 100 g, and total sugars in an amount of 10-20 g per 100 g; and
wherein the ratio in the soluble cascara powder product of the first coffee cherry fruit to the second coffee cherry fruit prior to processing is between 55:45 and 65:35, and
wherein the ratio in the soluble cascara powder product of the first soluble cascara powder to the second soluble cascara powder is between 0.95:1.05 and 1:05:0.95.

2. The soluble cascara powder product of claim 1 wherein the first soluble cascara powder has a gallic acid content of 1800-2500 μg/g and the second soluble cascara powder has a gallic acid content of 20-50 μg/g.

3. The soluble cascara powder product of claim 1 wherein the soluble cascara powder product is added to a beverage product in an amount of 2.5 -7.5 g of soluble cascara powder product per 350 ml of beverage product.

4. The soluble cascara powder product of claim 1 wherein a solids yield of the first coffee cherry fruit is 35% and a solids yield of the second coffee cherry fruit is 45%.

5. The soluble cascara powder product of claim 1 wherein the soluble cascara powder product comprises a total phenolic content of at least 40 mg GAE/g.

6. The soluble cascara powder product of claim 1 wherein the carrier used to encapsulate the first concentrated extract and the second concentrated extract is selected from the group consisting of maltodextrin, inulin, cyclodextrins, gum arabic, other encapsulating agents, and anti-caking agents.

7. The soluble cascara powder product of claim 1 wherein the first soluble cascara powder, the second soluble cascara powder, and the soluble cascara powder product have a microbiological load of less than 50,000 CFU.

8. A soluble cascara powder product comprising:
a first soluble cascara powder comprising a total phenolic content in an amount of 55-70 mg GAE/g, 0.5-1.2% caffeine, 9-13 g dietary fiber per 100 g, and 5-10 g sugar per 100 g; and
a second soluble cascara powder comprising total phenolic content of about 20-35 mg GAE/g, 0.5-1.2% caffeine, 5-8 g dietary fiber per 100 g, and 20-35 g sugar per 100 g;
wherein the soluble cascara powder product comprises a blend of the first soluble cascara powder and the second soluble cascara powder to obtain a soluble cascara powder product comprising caffeine in an amount of 0.5-2.0%, a total phenolic content of about 30-55 mg GAE/g per 100 g, dietary fiber of 5-12 g per 100 g, and total sugars in an amount of 10-20 g per 100 g;
wherein the ratio in the soluble cascara powder product of the first soluble cascara powder to the second soluble cascara powder is between 0.95:1.05 and 1:05:0.95.

9. The soluble cascara powder product of claim 8, wherein the product provides a turbidity of 100 or less NTU at an aqueous concentration of 0.3%.

10. The soluble cascara powder product of claim 9, wherein the product provides a turbidity of 20 or less NTU at an aqueous concentration of 0.3%.

11. The soluble cascara powder product of claim 8, wherein the product provides a turbidity between 100-500 NTU at an aqueous concentration of 0.3%.

12. The soluble cascara powder product of claim 8, wherein the soluble cascara powder product comprises a microbiological load of less than 50,000 CFU.

13. The soluble cascara powder product of claim 8, wherein the soluble cascara powder product comprises a hydrogen atom transfer activity level of 13,000-34,000 μmol Trolox/100 g sample as measured by a ORAC assay.

14. The soluble cascara powder product of claim 8, wherein the soluble cascara powder product comprises a single electron transfer activity level of 6,000-21,000 μmol Trolox/100 g sample as measured by a ABTS assay.

15. The soluble cascara powder product of claim 8, wherein the soluble cascara powder product comprises a prooxidant activity level such that a 1.25 mg/mL sample produces 1.2-5.6 μM of hydrogen peroxide over 24 hours.

16. A process for the preparation of a cascara powder product comprising:
wet pulping to separate coffee fruit from coffee beans;
drying the separated coffee fruit;
extracting cascara from the separated coffee fruit by treating the coffee fruit with sonication in a solvent at a temperature that is 65° or higher to obtain a first cascara extract;
concentrating the first cascara extract to a soluble solids content of at least 20% to form a first concentrated cascara powder extract;
encapsulating the first concentrated extract with a carrier; and
spray drying the first concentrated cascara powder extract.

17. The process of claim 16, further comprising performing a dewatering treatment on the separated coffee fruit after the sonication treatment.

18. The process of claim 16, wherein no dewatering treatment is performed.

19. The process of claim 16, further comprising adding the encapsulated concentrated cascara extract into a beverage or edible food product.

20. The process of claim 16, further comprising blending the first concentrated cascara powder extract with a second concentrated cascara powder extract, wherein the second concentrated cascara powder extract is made from a second, different type of coffee fruit, or the second concentrated cascara powder extract is made from the same coffee fruit but from a different processing method, or where the second concentrated cascara powder extract is made from a second, different type of coffee fruit and second concentrated cascara powder extract is made from a different processing method.

21. The process of claim 1, wherein the extraction solvent is hot water at 85-95° C., and wherein the extracting with the extraction solvent is performed for 120 minutes or more.
